(19) United States
(12) Patent Application Publication
(10) Pub. No.: US 2010/0175533 A1
(43) Pub. Date: Jul. 15, 2010

(54) HYBRID NECK MOUNT

(76) Inventor: Mark Leuchter, Philadelphia, PA (US)

Correspondence Address: DLA PIPER LLP (US ), 2000 UNIVERSITY AVENUE, EAST PALO ALTO, CA, 94303-2248, US

(21) Appl. No.: 12/353,165

(22) Filed: Jan. 13, 2009

(51) Int. Cl. G10D 3/00

(52) U.S. Cl. 84/293

(57) ABSTRACT

A musical instrument capable of obtaining direct tone transfer from the neck wood to the body wood as well as dramatically increased resonance sustain. The musical instrument comprises a neck portion having an extended neck tenon running a predetermined distance beyond the area of the fretboard, a body portion having a neck pocket designed to accommodate the extended neck tenon, a neck-to-body joint that combines connecting the body and neck tenon via metal screws through the back of the instrument as well as laminating/hard-gluing the neck to the wooden top of the instrument.

### BACKGROUND OF THE INVENTION

The last 50 years of electric guitar construction have seen two basic types of design in the way a guitar neck is joined to the body of an electric guitar. The first is the Bolt In method, where the neck 1 is secured to the full body 2 of the guitar with screws 3. This is illustrated in FIG. 1. The second is the Set Neck method, where a neck pocket 4 is carved into the full body of the guitar 5 and the neck 6 is hard-glued into the pocket. This is illustrated in FIGS. 2A-2C.

The two methods have respective advantages and disadvantages. The Bolt In method has direct wood to wood contact, i.e., the naked wood of the neck is directly in contact with the naked wood of the body, and this results in excellent tone transfer (resonance from the neck is transferred to the body) and sharp, quick note attack. All of this affects the way in which the guitar's electronics sense the string vibration and eventually transform it into an electric signal sent out to an amplifier, leading to a clear, bright tone. However, these designs generally do not result in great note sustain. The Set Neck method has a less defined attack and compromised tone transfer because the wood from the neck and the wood from the body are connected by a thin layer of glue that actually keeps them from directly contacting each other. Due to this design, the brightness of the tone suffers significantly. However, the glue fuses the two pieces into a single matrix yielding much greater resonance sustain which is a very desirable feature.

In recent years, some guitar builders have attempted to circumvent the problems inherent in both methods of design. In some cases, guitar builders have built necks with wood that extends well beyond the range of the fretboard (this is called an extended neck tenon), gluing this extension deep into a neck pocket carved into the full guitar body. This creates an added presence of tone due to the increase of neck wood that resonates with the strumming of the strings, but in every case where this method has been employed, the gluing of the extended neck tenon into the body still hinders direct tone transfer (compromising brightness and clarity) and quick note attack. Other builders have designed necks with extended tenons that are bolted into a deep neck pocket carved into the full body of the guitar. This retains the tone transfer and attack of the Bolt In method and yields a slight increase in sustain due to the additional neck wood (greater neck wood mass yields increased sustain). Nevertheless, the wood from the neck and the wood from the body are still two distinct entities and the resulting sustain is inferior to the Set Neck method.

An example of yet another modern design is described in Applicants' prior U.S. patent application Ser. No. 10/126,922 (now abandoned). The design described in said application improved upon the conventional extended neck tenon design by causing the wood from the neck to extend substantially throughout the length of the guitar. However, contrary to conventional designs, where the neck extends throughout the entire length of the body (the “through the body” construction), or throughout the area where the hardware is to be mounted (the “set through neck” construction), the neck tenon extends a predetermined distance into a groove that is cut into the body portion. This aspect preferably leaves the bridge, tailpiece and the bridge position pickup to be mounted upon the body wood, not over the neck tenon. The sound captured by the bridge position pickup is therefore not uniform with the vibrations of the neck wood. Rather, like the traditional instruments, it resonates in concert with the body wood. This allows the bridge pickup to more faithfully emulate a vintage tone, since it operates in much the same way as traditional guitars, all the while benefiting from the added sustain of the extended neck tenon.

This design feature also allows the neck position pickup to function better in reproducing its desired tone, which typically comes from a different wood combination with different tonal qualities in traditional instruments. Since the neck pickup in traditional instruments is not mounted onto the neck tenon, but resonates with the body wood, specific types of body woods are generally needed for specific types of pickups in order for the neck position pickup not to be drowned out or muted by the resonance of the body wood.

The neck-to-body joint also allows the neck pickup to be mounted directly above the neck tenon, thus allowing for uniform resonance with the neck. As such, the body wood of the guitar does not absorb the timbre of the neck position pickup. This aspect, coupled with the electronic aspects, allows for a more faithful reproduction of the pickup's intended sound than was previously available using conventional guitar designs. Additionally, the neck-to-body joint design allows for increased sustain without adversely affecting the instrument's ability to reproduce vintage tones.

Notwithstanding these improvements, it has recently been discovered that even the improved design remained problematic, in part because it borrowed from an established method of guitar design that traditionally glued a neck into place. In every case in the history of guitar making, gluing a neck into place to obtain sustain negates the possibility of bolting it in to obtain clear tone and attack. The above design intended to compensate for this deficiency by obtaining brighter tone through the electronics. However, it would be more beneficial to achieve clear tone and attack solely through the guitar's inherent structural acoustics. The present design achieves this.

### SUMMARY OF THE INVENTION

The Hybrid Neck Mount method offers a completely new method of neck-to-body construction, and one that combines the most useful properties of the Bolt In and Set Neck approaches while completely sidestepping their limitations. It allows for the tone transfer and attack of the Bolt In method while also allowing for the sustaining properties of the Set Neck method. In one embodiment, this is achieved through constructing the guitar neck with an extended tenon (FIG. 3) and joining it to the guitar body via a unique combination of bolting the pieces together (FIGS. 5A and 5B) and laminating/hard gluing a final piece of wood over the face of the instrument (FIG. 6).

### BRIEF DESCRIPTION OF THE SEVERAL VIEWS OF THE DRAWING

FIG. 1 is a side view of the typical Bolt In neck-to-body joint, whereby the neck is fastened to the full guitar body via several screws inserted through the back of the body into the neck wood, pulling the two pieces together tightly.

FIG. 2A is a side view of the typical Set Neck neck-to-body joint (some parts removed from view, indicated by dotted line, to show detail), whereby the neck is glued into a neck pocket carved into the full body of the guitar and clamped in until the glue dries. The dried glue fuses the neck wood to the body wood.

FIG. 2B is a front view of the neck pocket carved into the guitar body before the neck is glued in to the guitar shown in FIG. 2A.

FIG. 2C is a front view of the neck glued into the neck pocket of the guitar of FIG. 2A.

FIG. 3 is a representative view of an embodiment of the Hybrid Neck Mount neck design, incorporating a neck tenon that extends beyond the fretboard area of the neck.

FIG. 4 is another representative view of the Hybrid Neck Mount body design, incorporating a neck pocket carved into the bottom body portion of the guitar to accommodate the neck tenon.

FIG. 5A is an angled front/partial side view demonstration of an embodiment of the Hybrid Neck Mount neck-to-body connection, whereby the neck tenon fits into the neck pocket of the bottom body portion of the guitar and is tightly fastened into place by screws inserted through the back of the bottom body portion.

FIG. 5B is another angled front/partial side view of an embodiment of the Hybrid Neck Mount neck-to-body connection, showing the neck tenon fitted into the neck pocket of the bottom body portion of the guitar.

FIG. 5C is a side view of an embodiment of the neck-to-body connection of the Hybrid Neck Mount, revealing the points where screws, inserted through the back of the bottom body portion, fasten the neck tenon to the bottom body portion. In this view, only two of the four screws can be seen.

FIG. 6 is a demonstration of an embodiment of the Hybrid Neck Mount top coupling stage, whereby the guitar top body portion is laminated/hard-glued over the neck tenon and the surrounding guitar bottom body portion, fusing all three pieces together.

FIG. 7 is a representative view of an embodiment of a guitar constructed in accordance with the Hybrid Neck Mount design of the present invention.

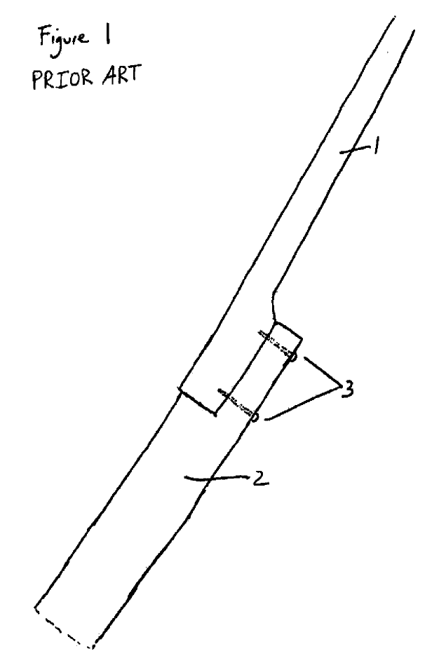

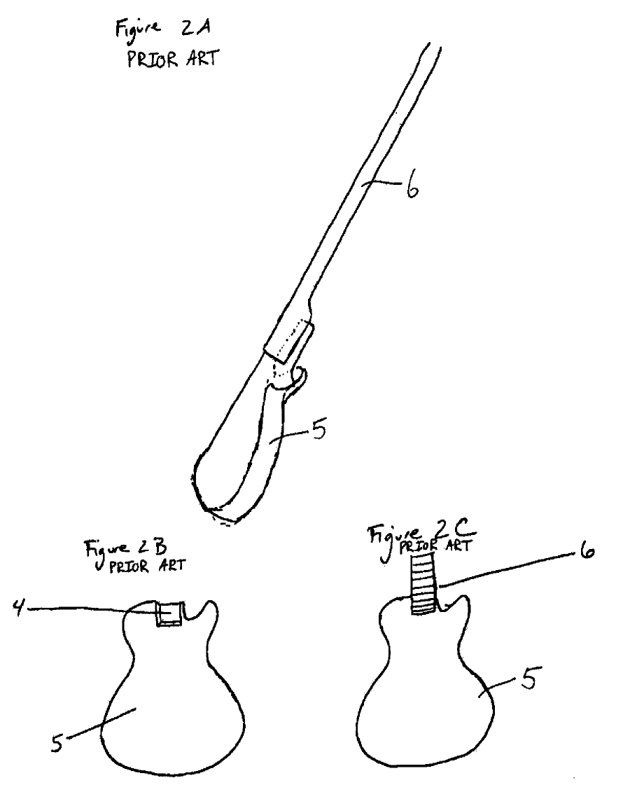

### DETAILED DESCRIPTION OF THE PREFERRED EMBODIMENT

The Hybrid Neck Mount is a method of constructing the neck-to-body joint of an electric guitar to obtain a Hybrid Neck Mounted guitar, and is described in the following manner:

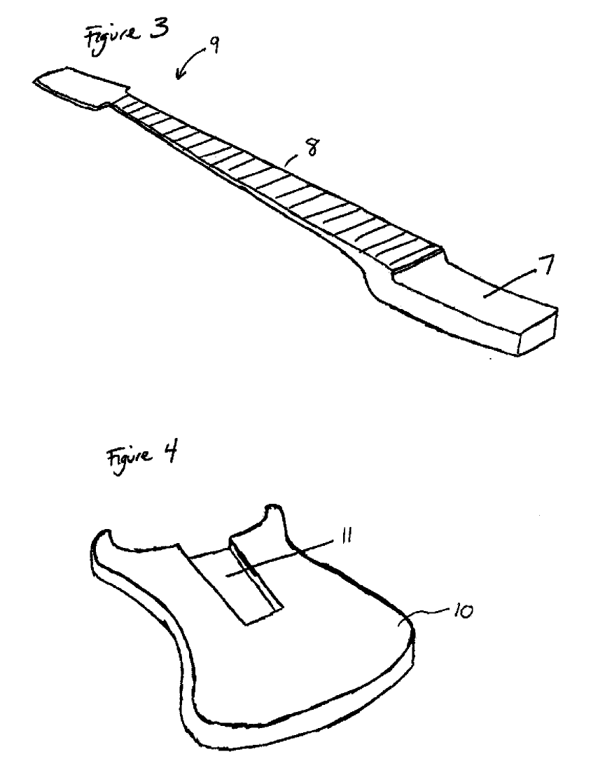

In a preferred embodiment, the guitar neck 9 is constructed with an extended tenon 7 that runs approximately seven inches beyond the fretboard 8. This is illustrated in FIG. 3. The guitar neck 9 is preferably made of maple because the traditional Stratocaster tone is derived from a maple guitar neck. While other materials can be used without departing from the invention, a dense wood with very bright tonal response, such as maple, is preferable. Other exemplary, but not unduly limiting, wood types could be rosewood or ebony. It should also be noted that the distance by which the extended tenon 7 runs beyond the fretboard 8 can be modified in alternative embodiments and is not a limiting factor of the disclosed design.

Preferably, the bottom layer of the guitar body 10 is constructed with a neck pocket 11 that can accommodate the extended tenon 7 of the specially designed guitar neck 9. This is illustrated in FIG. 4. As illustrated, the neck pocket 11 is preferably formed by cutting a channel into the bottom portion of the guitar body 10 that is exactly as wide as the neck tenon 7. Ordinarily, there is no limitation on the size of this channel, because neck tenon sizes have been known to differ based on minor alterations or the needs or preferences of particular instrument players. Notwithstanding this, it is desirable for the channel to be cut into the bottom body portion 9 to match the dimensions of the neck tenon 7.

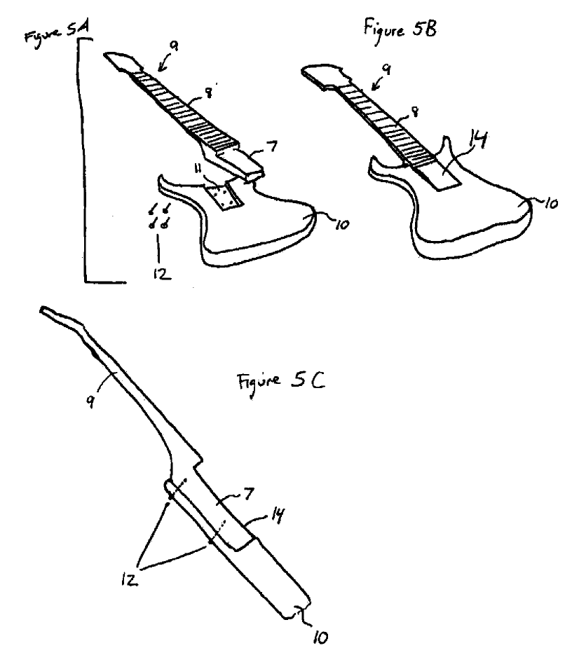

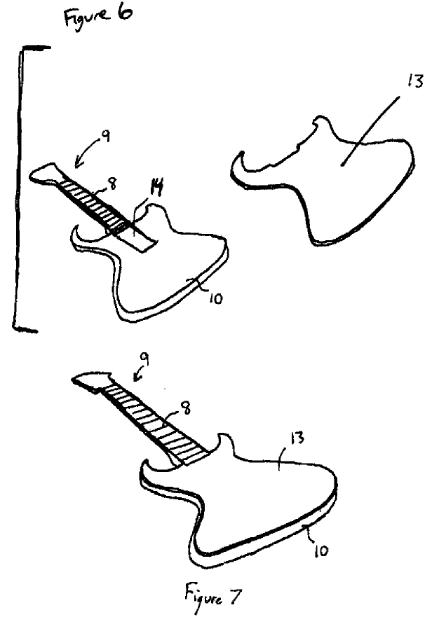

The neck tenon 7 is fitted into the pocket 11 in the bottom layer of the guitar body 10 and is then preferably bolted in tightly with metal screws 12. Any screw size can be used so long as the screws are thick enough to establish a strong connection between the wood of the neck tenon 7 and the wood of the bottom layer of the guitar body 10. This is illustrated in FIGS. 5A-5C, respectively. Other mechanisms for fixing the neck tenon 7 into the pocket 11 in the bottom portion of the guitar body 10 can be used in alternative embodiments without departing from the invention, so long as they result in a tight wood-to-wood contact between the neck tenon 7 and the guitar body bottom portion 10. A non-limiting alternative example is using metal bolts of varying sizes and thicknesses to fix the neck tenon 7 to the guitar body bottom portion 10. In such example, the metal bolts would be screwed into a receptacle that is glued into the wood of the neck tenon 7. Regardless of the mechanism used, fitting the neck tenon 7 into the pocket 11 in such way advantageously results in the tone transfer and note attack of the conventional Bolt In design since so much more wood from the neck tenon 7 contacts the guitar body bottom portion 10.

The top layer of the guitar 13—a piece of shaped wood (usually around a half-inch to three-quarters of an inch in thickness, though by no means limited to this thickness) is preferably laminated/hard glued over the exposed surface 14 of the extended neck tenon 7 as well as the surrounding bottom layer of the guitar body 10. This is illustrated in FIG. 6. The preferred type of laminate or glue used to affix the top layer of the guitar 13 to the bottom layer of the guitar body 10 and the extended neck tenon 7 is typical Luthier's glue, known as TiteBond® or TiteBond® II, however alternative types of laminates or glues can be used without departing from the invention. In alternative embodiments the top layer of the guitar 13 can be affixed over the exposed surface 14 of the extended neck tenon 7 using other commonly known techniques. Once the glue is dried, this preferably creates a single matrix of wood incorporating the neck tenon 7, the bottom layer of the guitar body 10 and the top layer of the guitar 13. In other words, in the preferred embodiment, the exposed face 14 of the neck tenon 7 is fused to the maple top 13, and the maple top 13 is also fused to the guitar body 10, since the maple top 13 fits over the entire face of the instrument. It is this unique fusion of the extended neck tenon 7, the bottom layer of the guitar body 10, and the top layer of the guitar 13 that results in the advantageous and utilitarian characteristics of the invention. FIG. 7 shows the resulting guitar constructed in accordance with the invention.

Indeed, among other advantages, this design advantageously preserves and transmits high-end acoustic frequencies from the neck to the body, thus affecting the strings, and eventually, the electrical signal emanating from the guitar. In Applicant's earlier design (disclosed in U.S. patent application serial number 10/126,922), the high-end bias was achieved through running one of the pickups (the neck pickup) through a certain electronics scenario, where the volume/tone potentiometers emphasize high-end frequencies. Thus, high end was obtained electronically, not acoustically. Furthermore, the high end would only be obtained by the neck pickup. The bridge pickup would receive and transmit traditional, warm/dark Gibson Les Paul type tones.

Among the unique characteristics of the current design in relation to Applicant's prior design is that the sonic frequency and tone of the present design is based on what is generated acoustically, whereas the sonic frequency/tone of the older design used the neck pickup and wiring to achieve this performance characteristic. While the sustain features of Applicant's prior design and the current design are similar, a purpose of the new design is not simply to obtain increased sustain, but to couple increased sustain with bright acoustic resonance for brighter tone and attack. This could not be achieved with the older design.

While the foregoing has been described with reference to particular embodiments of the invention, it will be appreciated by those skilled in the art that changes in these embodiments may be made without departing from the principles and spirit of the invention.

What is claimed is:

1. A musical instrument, comprising:
an instrument body bottom layer having a neck pocket disposed within it to accommodate an extended neck tenon; and
an instrument body top layer affixed to the instrument body bottom layer and in direct contact with an exposed surface of the extended neck tenon.

2. The musical instrument of claim 1, wherein the instrument body top layer is affixed to the instrument body bottom layer and to the exposed surface of the extended neck tenon.

3. The musical instrument of claim 1, wherein the instrument body bottom layer comprises wood.

4. The musical instrument of claim 3, wherein the instrument body bottom layer is shaped.

5. The musical instrument of claim 1, wherein the neck pocket is carved into the instrument body bottom layer.

6. The musical instrument of claim 1, wherein the extended neck tenon comprises wood.

7. The musical instrument of claim 1, wherein the extended neck tenon is affixed to the instrument body bottom layer.

8. The musical instrument of claim 7, wherein the extended neck tenon is bolted to the instrument body bottom layer.

9. The musical instrument of claim 1, wherein the instrument body top layer comprises wood.

10. The musical instrument of claim 9, wherein the instrument body top layer is shaped.

11. The musical instrument of claim 1, wherein the instrument body bottom layer and the instrument body top layer comprise uniformly shaped wood.

12. The musical instrument of claim 1, wherein the instrument body top layer is laminated over the exposed surface of the extended neck tenon and the surrounding instrument body bottom layer.

13. The musical instrument of claim 2, wherein the instrument body top layer is laminated over the exposed surface of the extended neck tenon and the surrounding instrument body bottom layer.

14. The musical instrument of claim 1, wherein the instrument body top layer is glued to the exposed surface of the extended neck tenon and the surrounding instrument body bottom layer.

15. The musical instrument of claim 2, wherein the instrument body top layer is glued to the exposed surface of the extended neck tenon and the surrounding instrument body bottom layer.

16. A musical instrument, comprising:
a wooden instrument body bottom layer having a neck pocket carved within it to accommodate a wooden extended neck tenon; and
a wooden instrument body top layer affixed to the wooden instrument body bottom layer and in direct contact with an exposed surface of the wooden extended neck tenon, such that tone transfer of the musical instrument results at least in part through direct wood-to-wood contact between the body wood of the carved neck pocket and the neck wood of the extended neck tenon.

17. The musical instrument of claim 16, wherein the wooden instrument body top layer is affixed to the wooden instrument body bottom layer and to the exposed surface of the wooden extended neck tenon.

18. The musical instrument of claim 16, wherein the wooden extended neck tenon is affixed to the wooden instrument body bottom layer.

19. The musical instrument of claim 18, wherein the wooden extended neck tenon is bolted to the wooden instrument body bottom layer.

20. The musical instrument of claim 16, wherein the wooden instrument body bottom layer and the wooden instrument body top layer comprise uniformly equivalent shapes.

21. The musical instrument of claim 16, wherein the wooden instrument body top layer is laminated over the exposed surface of the wooden extended neck tenon and the surrounding wooden instrument body bottom layer.

22. The musical instrument of claim 17, wherein the wooden instrument body top layer is laminated over the exposed surface of the wooden extended neck tenon and the surrounding wooden instrument body bottom layer.

23. The musical instrument of claim 16, wherein the wooden instrument body top layer is glued to the exposed surface of the wooden extended neck tenon and the surrounding wooden instrument body bottom layer.

24. The musical instrument of claim 17, wherein the wooden instrument body top layer is glued to the exposed surface of the wooden extended neck tenon and the surrounding wooden instrument body bottom layer.

25. A musical instrument, comprising:
a wooden instrument body bottom layer having a neck pocket carved within it to accommodate a wooden extended neck tenon; and
a wooden instrument body top layer affixed to the wooden instrument body bottom layer and in direct contact with an exposed surface of the wooden extended neck tenon, such that note attack of the musical instrument results at least in part through direct wood-to-wood contact between the body wood of the carved neck pocket and the neck wood of the extended neck tenon.

26. The musical instrument of claim 25, wherein the wooden instrument body top layer is affixed to the wooden instrument body bottom layer and to the exposed surface of the wooden extended neck tenon.

27. The musical instrument of claim 25, wherein the wooden extended neck tenon is affixed to the wooden instrument body bottom layer.

28. The musical instrument of claim 26, wherein the wooden extended neck tenon is bolted to the wooden instrument body bottom layer.

29. The musical instrument of claim 25, wherein the wooden instrument body bottom layer and the wooden instrument body top layer comprise uniformly equivalent shapes.

30. The musical instrument of claim 25, wherein the wooden instrument body top layer is laminated over the exposed surface of the wooden extended neck tenon and the surrounding wooden instrument body bottom layer.

31. The musical instrument of claim 26, wherein the wooden instrument body top layer is laminated over the exposed surface of the wooden extended neck tenon and the surrounding wooden instrument body bottom layer.

32. The musical instrument of claim 25, wherein the wooden instrument body top layer is glued to the exposed surface of the wooden extended neck tenon and the surrounding wooden instrument body bottom layer.

33. The musical instrument of claim 26, wherein the wooden instrument body top layer is glued to the exposed surface of the wooden extended neck tenon and the surrounding wooden instrument body bottom layer.

34. A musical instrument, comprising:
a wooden instrument body bottom layer having a neck pocket carved within it to accommodate a wooden extended neck tenon; and
a wooden instrument body top layer affixed to the wooden instrument body bottom layer and in direct contact with an exposed surface of the wooden extended neck tenon, such that both note attack and tone transfer of the musical instrument results at least in part through direct wood-to-wood contact between the body wood of the carved neck pocket and the neck wood of the extended neck tenon.

35. The musical instrument of claim 34, wherein the wooden instrument body top layer is affixed to the wooden instrument body bottom layer and to the exposed surface of the wooden extended neck tenon.

36. The musical instrument of claim 34, wherein the wooden extended neck tenon is affixed to the wooden instrument body bottom layer.

37. The musical instrument of claim 35, wherein the wooden extended neck tenon is bolted to the wooden instrument body bottom layer.

38. The musical instrument of claim 34, wherein the wooden instrument body bottom layer and the wooden instrument body top layer comprise uniformly equivalent shapes.

39. The musical instrument of claim 34, wherein the wooden instrument body top layer is laminated over the exposed surface of the wooden extended neck tenon and the surrounding wooden instrument body bottom layer.

40. The musical instrument of claim 35, wherein the wooden instrument body top layer is laminated over the exposed surface of the wooden extended neck tenon and the surrounding wooden instrument body bottom layer.

41. The musical instrument of claim 34, wherein the wooden instrument body top layer is glued to the exposed surface of the wooden extended neck tenon and the surrounding wooden instrument body bottom layer.

42. The musical instrument of claim 35, wherein the wooden instrument body top layer is glued to the exposed surface of the wooden extended neck tenon and the surrounding wooden instrument body bottom layer.

43. A musical instrument, comprising:
an instrument body bottom layer having a neck pocket disposed within it to accommodate an extended neck tenon; and
an instrument body top layer affixed to the instrument body bottom layer and in direct contact with an exposed surface of the extended neck tenon, such that sustain of the musical instrument results at least in part from the fusion of the exposed surface of the extended neck tenon to the instrument body top layer.

44. The musical instrument of claim 43, wherein the instrument body top layer is affixed to the instrument body bottom layer and to the exposed surface of the extended neck tenon.

45. The musical instrument of claim 43, wherein the instrument body bottom layer comprises wood.

46. The musical instrument of claim 45, wherein the instrument body bottom layer is shaped.

47. The musical instrument of claim 43, wherein the neck pocket is carved into the instrument body bottom layer.

48. The musical instrument of claim 43, wherein the extended neck tenon comprises wood.

49. The musical instrument of claim 43, wherein the extended neck tenon is affixed to the instrument body bottom layer.

50. The musical instrument of claim 49, wherein the extended neck tenon is bolted to the instrument body bottom layer.

51. The musical instrument of claim 43, wherein the instrument body top layer comprises wood.

52. The musical instrument of claim 51, wherein the instrument body top layer is shaped.

53. The musical instrument of claim 43, wherein the instrument body bottom layer and the instrument body top layer comprise uniformly shaped wood.

54. The musical instrument of claim 43, wherein the instrument body top layer is laminated over the exposed surface of the extended neck tenon and the surrounding instrument body bottom layer.

55. The musical instrument of claim 44, wherein the instrument body top layer is laminated over the exposed surface of the extended neck tenon and the surrounding instrument body bottom layer.

56. The musical instrument of claim 43, wherein the instrument body top layer is glued to the exposed surface of the extended neck tenon and the surrounding instrument body bottom layer.

57. The musical instrument of claim 44, wherein the instrument body top layer is glued to the exposed surface of the extended neck tenon and the surrounding instrument body bottom layer.

58. A musical instrument, comprising:
a wooden instrument body bottom layer having a neck pocket carved within it to accommodate a wooden extended neck tenon; and
a wooden instrument body top layer affixed to the wooden instrument body bottom layer and in direct contact with an exposed surface of the wooden extended neck tenon, such that sustain of the musical instrument results at least in part from the fusion of the exposed surface of the wooden extended neck tenon to the wooden instrument body top layer.

59. The musical instrument of claim 58, wherein the wooden instrument body top layer is affixed to the wooden instrument body bottom layer and to the exposed surface of the wooden extended neck tenon.

60. The musical instrument of claim 58, wherein the wooden extended neck tenon is affixed to the wooden instrument body bottom layer.

61. The musical instrument of claim 60, wherein the wooden extended neck tenon is bolted to the wooden instrument body bottom layer.

62. The musical instrument of claim 58, wherein the wooden instrument body bottom layer and the wooden instrument body top layer comprise uniformly equivalent shapes.

63. The musical instrument of claim 58, wherein the wooden instrument body top layer is laminated over the exposed surface of the wooden extended neck tenon and the surrounding wooden instrument body bottom layer.

64. The musical instrument of claim 59, wherein the wooden instrument body top layer is laminated over the exposed surface of the wooden extended neck tenon and the surrounding wooden instrument body bottom layer.

65. The musical instrument of claim 58, wherein the wooden instrument body top layer is glued to the exposed surface of the wooden extended neck tenon and the surrounding wooden instrument body bottom layer.

66. The musical instrument of claim 59, wherein the wooden instrument body top layer is glued to the exposed surface of the wooden extended neck tenon and the surrounding wooden instrument body bottom layer.

67. A method for fabricating a hybrid neck mounted musical instrument, comprising the steps of:
disposing a neck pocket within an instrument body bottom layer to accommodate an extended neck tenon; and
affixing an instrument body top layer to the instrument body bottom layer such that the instrument body top layer is in direct contact with an exposed surface of the extended neck tenon.

68. The method of claim 67, wherein the instrument body bottom layer and the instrument body top layer each comprise wood.

69. The method of claim 68, wherein the instrument body bottom layer and the instrument body top layer comprise uniformly equivalent shapes.

70. The method of claim 67, wherein disposing step comprises carving the neck pocket into the instrument body bottom layer.

71. The method of claim 67, wherein the extended neck tenon comprises wood.

72. The method of claim 67, further comprising the step of affixing the extended neck tenon to the instrument body bottom layer.

73. The method of claim 72, wherein the step of affixing comprises bolting the extended neck tenon to the instrument body bottom layer.

74. The method of claim 67, wherein the affixing step comprises affixing the instrument body top layer is affixed to the exposed surface of the extended neck tenon and to the surrounding instrument body bottom layer.

75. The method of claim 67, wherein the affixing step comprises laminating the instrument body top layer over the exposed surface of the extended neck tenon and the surrounding instrument body bottom layer.

76. The method of claim 74, wherein the affixing step comprises laminating the instrument body top layer over the exposed surface of the extended neck tenon and the surrounding instrument body bottom layer.

77. The method of claim 67, wherein the affixing step comprises gluing the instrument body top layer to the exposed surface of the extended neck tenon and to the surrounding instrument body bottom layer.

78. The method of claim 74, wherein the affixing step comprises gluing the instrument body top layer to the exposed surface of the extended neck tenon and to the surrounding instrument body bottom layer.

79. A method for fabricating a hybrid neck mounted musical instrument, comprising the steps of:
carving a neck pocket within a wooden instrument body bottom layer to accommodate a wooden extended neck tenon, such that there exists direct wood-to-wood contact between the body wood of the neck pocket and the neck wood of the extended neck tenon; and
affixing an instrument body top layer to the instrument body bottom layer such that the instrument body top layer is in direct contact with an exposed surface of the extended neck tenon.

80. A method for fabricating a hybrid neck mounted musical instrument, comprising the steps of:
disposing a neck pocket within an instrument body bottom layer to accommodate an extended neck tenon; and
affixing an instrument body top layer to the instrument body bottom layer such that the instrument body top layer is in direct contact with an exposed surface of the extended neck tenon and there exists a fusion between the exposed surface of the extended neck tenon and the instrument body top layer.

81. A method for fabricating a hybrid neck mounted musical instrument, comprising the steps of:
carving a neck pocket within a wooden instrument body bottom layer to accommodate a wooden extended neck tenon, such that there exists direct wood-to-wood contact between the body wood of the neck pocket and the neck wood of the extended neck tenon; and
affixing an instrument body top layer to the instrument body bottom layer such that the instrument body top layer is in direct contact with an exposed surface of the extended neck tenon and there exists a fusion between the exposed surface of the extended neck tenon and the instrument body top layer.
